(19) United States
(12) Patent Application Publication
(10) Pub. No.: US 2007/0241866 A1
(43) Pub. Date: Oct. 18, 2007

(54) Wireless service tool for automated protection systems

(76) Inventors: Troy Cool, Concord, CA (US); Joseph Grant, Davie, FL (US); Michael L. Jobe, Wayne, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/403,711

(22) Filed: Apr. 13, 2006

(51) Int. Cl. H04Q 1/20

(52) U.S. Cl. 340/10.41

(57) ABSTRACT

A service tool accesses a building system to wirelessly configure, test, troubleshoot and control a building fire protection system. Using wireless communication with a fire alarm control panel, the service tool provides for remote viewing of a control panel. The service tool may be used for remote control for functionality of a fire alarm control panel or other devices of a building fire protection system. The service tool may display information such as status indicators that correspond to a display on a remote control panel. The service tool may be used to confirm and/or monitor an installation, test functionality, diagnose and/or troubleshoot problems.

### BACKGROUND

The invention relates to automated protection systems, and particularly to remote servicing, monitoring and control of building fire and security systems.

Fire and security protection systems include distributed components that together form an automated system for monitoring for and protecting against hazards within a building or facility. The system automatically detects and reports hazards, such as a fire, smoke, combustion, or an intrusion. The system may report a hazard by sounding an alarm and/or notifying an agent such as a local fire protection organization. The system may also trigger an appropriate corrective action such as by activating a deluge and/or extinguishing system. Similarly, the system may identify a hazard in response to the tripping of an extinguishing or deluge system. The system may be integrated with other building systems that manage heating, ventilation, air conditioning (HVAC), environmental air quality, or other controlled applications for a building or facility.

Components of a fire and security protection system include sensors, heat detectors, smoke detectors, CO detectors, CO₂ detectors, motion detectors, alarms, sirens, annunciators, power supplies, displays, monitors, control panels, air samplers, extinguishers, valves, actuators, call switches and other devices used to for detector hazards within a building. The components monitor environmental conditions to detect hazardous conditions, provide user access points, monitor status of detectors, and/or provide security monitoring for the building or portions of a building. The system components may communicate through wired and/or wireless connections.

Tools are used to configure and/or verify a configuration of the fire protection system, diagnostic testing, servicing and troubleshooting the system. Tool also may be used for periodic and/or annual testing or performance verification of the system. The tools are hardwired to a dedicated access point located at a remote location within a building, such as a control panel. The tools are not mobile, and may not provide real-time location-specific information for a technician. The tools often require multiple persons to perform routine testing and verification. Servicing, troubleshooting and monitoring of the fire protection system may be labor-intensive and require multiple expensive devices.

### BRIEF SUMMARY

By way of introduction, the embodiments described below include methods, processes, apparatuses, and systems for servicing automated protection systems, including fire protection systems, automated security systems and/or integrated systems having automated fire and/or security protection (collectively and/or individually “Protection Systems”). The service tool accesses a protection system, and the components, and/or groups of components, of the protection system. The service tool may communicate with the protection system via one or more components of the protection system using wireless communications, wired communications and/or combination of both wired and wireless communications.

The service tool provides a remote access point to a protection system and its components. The service tool may communicate directly with the protection system and its components or may indirectly communicate with the protection system and/or it components, via a proxy such as computer communicatively coupled with one or more components of the protection system. By communicating with the protection system and its components, the service tool provides a portable portal to the protection system. The portal provides a mobile access point to information for the protection system for servicing, monitoring, testing, and troubleshooting a protection system and its components. A user may identify a status of one or more components of a protection system, verify performance of the protection system and it components, perform testing, monitor system functions, diagnose, analyze and troubleshoot problems, adjust and/or reconfigure parameters, operate or trigger an operation of the system and its components, and monitor system operation.

The service tool includes a user interface that displays information related to the protection system, and/or its components. For example, the interface may display a status of the system and it components, an indication of a supervisory condition, information related to a communication between and among the components, and information concerning system events such as alarms and triggers. The information may be presented in a visual and/or audible format. For example, a text message and/or graphics may illustrate a status for a device or group of devices, an audible alarm may report critical information, and/or an audible voice or pre-recorded message may describe a condition or status of the protection system.

The service tool includes a transceiver to wirelessly communicate information. The protection system may also have a transceiver to wirelessly transmit information to and receive information from the service tool. The transceiver of the protection system may be integrated with the protection system, may be a component of the protection system, or a separable device operatively coupled with protection system. The service tool includes a controller that processes information received via the user interface, received from the protection system, and transmitted to the protection system.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components in the figures are not necessarily to scale, emphasis instead being placed upon illustrating the described principles. In the figures, like reference numerals designate corresponding parts throughout the different views.

FIG. 1 is an example of a service tool used with an exemplary protection system.

FIG. 2 illustrates a block diagram for an exemplary service tool for a protection system.

FIG. 3 illustrates an example of a wireless service tool in communication with a protection system.

FIG. 4 illustrates an example of a user interface for the service tool of FIG. 5.

FIG. 5 illustrates an example of a handheld service tool.

### DESCRIPTION OF THE PRESENTLY PREFERRED EMBODIMENTS

A service tool for protection systems may be used prior to, during, and after installation of a protection system and for testing of an existing system. The service tool may be a portable handheld device having a wireless transceiver for wirelessly communicating with a fire protection system. The service tool provides a remote access point to the protection system via one or more components of a protection system. The service tool may provide the same or similar functionality of the device, at a remote location. The service tool may receive configuration and status data from a device of the protection system. A user interface for the service tool may display information associated with information collected and displayed by a device of the protection system. The service tool 110 may be used prior to, during, or after installation of a protection system. In an example, the service tool 110 communicates with a control panel for a fire protection system to display information provided at the control panel and to provide remote control of the fire control panel.

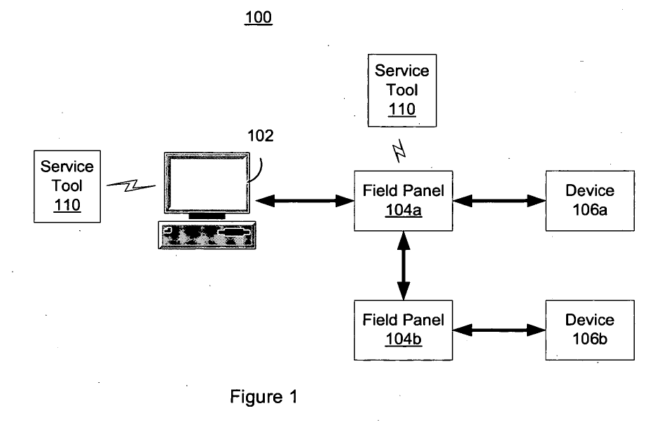

FIG. 1 illustrates a block diagram of a service tool 110 and a protection system 100 that provides control functionality for one or more building, or facility, operations. The illustrated protection system 100 is configured to automate control for hazard detection, such as a fire detection and suppression system for a building, and is provided only as an example of a type of automated system. Although various examples of the service tool 110 and protection system 100 are described, the service tool 110 may be used in a variety of applications and may be used with many devices and automated systems. The protection system 100 includes control processes for monitoring an environment, detecting hazards, and reporting detecting conditions. For example, the protection system 100 includes components, or equipment, that detect fire, combustion by-products and heat and extreme environmental changes. The components are positioned, or distributed, throughout the building or facility to provide early warnings of a fire or other potentially hazardous condition. The components may generate and/or receive information related to a specific event, condition, status, acknowledgement, control, user access, combinations thereof and the like. The components also or alternatively may be responsive to signals, may route communications, and/or may carry out an instruction received by or in a signal. The components may communicate or route the information between and among components of the system from a source to a destination. For example, the service tool 110 may be used with any type of automated building control system including a building security and loss protection system, a burglary/intrusion detection system, a HVAC system, air quality system, industrial control system, hazard detection and/or prevention system, a lighting system, combinations or integrations thereof, and the like. In an embodiment, the protection system 100 may be a SYNOVA™ system provided by Siemens Building Technologies, Inc. of Buffalo Grove, Ill.

The protection system may be arranged in zones. Each zone may have multiple components for detecting and reporting hazards. The components of a zone may communicate using a loop communication and/or over a bus. The protection system 100 includes a central panel, or field panel 104a. More or less field panels 104a may be arranged in a protection system 100 other than that shown in FIG. 1. The field panel 104a collects information related to operational status of the system and its components. The field panel 104a monitors one or more zones of the protection system. The information collected or monitored at the field panel 104a is provided via a user interface. The user interface may include lights, LED's, video or picture display, a monitor, graphics array, and textual data. In an embodiment, the filed panel 104a is a fire control panel having video display for presenting real-time information associated with the protection system. The display may illustrate that the system is operating properly and that the components, or detectors, of a monitored zone are properly operating. The display may also indicate that a hazard has been detecting and provide information as to the type of hazard, and location of the detected hazard. The display may be used to provide other diagnostic, and service information. A user may select to view a status of the system as a whole, or its subparts, such as a zone, or specific detectors and actuators of a zone. The field panel 104a may also include a network interface, a communications device, such as a telephone, a microphone or call system, a terminal module, a power supply, a processor and other devices for administering control for the protection system.

The field panel 104a may be networked with other one or more other field panels 104b. The field panel 104b may be configured similar to field panel 104a. For example, filed panel 104a may be a central field panel for a large multi-story building, and field panel 104b may be arranged as a central panel for a floor of the building. Field panels 104a may be communicatively coupled with field panel 104b to report information received from field panel 104b. The field panels 104a and 10b may be arranged in a bus configuration where the filed panels 104a and 104b are mutually communicatively coupled to a common bus, a loop configuration where the panels are connected in series to form a loop, and/or in a star configuration, where multiple control panels are coupled to a central control panel. Field panel 104a also may be arranged to receive and report information from one or more devices 106a. Field panel 106b may be arranged to receive and report information from one or more devices 106b. The field panels 104a and 104b, and the devices 106a and 106b may communicate information using a wired connection and/or wireless connection in accordance with a wireless communications protocols. For example, the field panels may wirelessly communicate information using a 802.15.4 communications protocols, IEEE 802.11x (e.g., 802.11a 802.11b, 802.11c . . . 802.11g), Wi-Fi, Wi-Max, Bluetooth, ZigBee, Ethernet, or other proprietary, standard, now known or later developed wireless communication protocols. Any now known or later developed network and transport algorithms may be used. Communication, transport and routing algorithms are provided on the appropriate devices. Any packet size or data format may be used.

Control and monitoring of a protection system are distributed to the field panels. A device 106a may periodically or continuously report a status of a monitored condition to field panel 106a. When the device 106a detects a hazard, the device 106a will report appropriate information to the field panel 106a. The filed panel will process the information to take appropriate action, such as sounding an alarm and reporting the condition. The field panel 104 may also activate actuators, such as fan or door lock, in the area where a hazard was detected. The field panel may also be used to provide functionality such as a request for an acknowledge from a component or components of a zone, a silence of an alarm, or override of a detected condition, a supervisory override, a reset of the protection system 100, and arming and disarming of devices 106a and 106b. The field panels 104a and 104b may also report information such as sensitivity settings for devices, voltages and battery supply information, a log of events, and other information relevant to the protection system 100.

The devices 106a and 106b may be a detector, a sensor, a manual call unit or other device that reports conditions and/or events. Additionally or alternatively, the devices 106a and 106b may be an actuator configured to perform an act in response to instructions, such as a command received from a filed panel. The devices 106a and 106b may be configured as a temperature or heat sensor, smoke detector, humidity sensor, fire sensor, occupancy sensor, air quality sensor, gas sensor, O₂, CO₂ or CO sensor or other now known or later developed sensors. The devices 106a and 106b may include micro-electro-mechanical sensors (“MEMS”) or larger sensors for sensing any environmental condition or event. As an actuator, the devices 106a and 106b may be arranged to control a damper, a heating or cooling element, sprinkler, valve, fan, strobe, lighting, alarm, bell, motor, or other device.

The exemplary protection system 100 may include at least one workstation 102. The workstation 102 may be an interactive video display terminal that provides a secondary display of information and operation of functions of the field control panel 104a. The workstation 102 may provide user access to the components of the protection system 100, such as the field panels 104a and 104b and devices 106a and 106b. The workstation 102 accepts modifications, changes, and alterations to the protection system 100. The workstation 102 may have a user interface with an input device or combination of input devices, such as a keyboard, voice-activated response system, a mouse or similar device. The workstation 102 may affect or change operations of the field panels 104a and 104b. The workstation 102 may process data gathered from the field panels 104a and 104b and maintain a log of events and conditions.

The service tool 110 may communicate with the fire protection system 100 through a communication connection with one or more components of the system 100. The service tool 110 may communicate information using wireless data transmission protocol. For example, the service tool 110 may wirelessly communicate with the field panel 104a and/or workstation 102. The service tool 110 also may communicate with field panel 104b through a wireless communication with field panel 104a and/or workstation 102

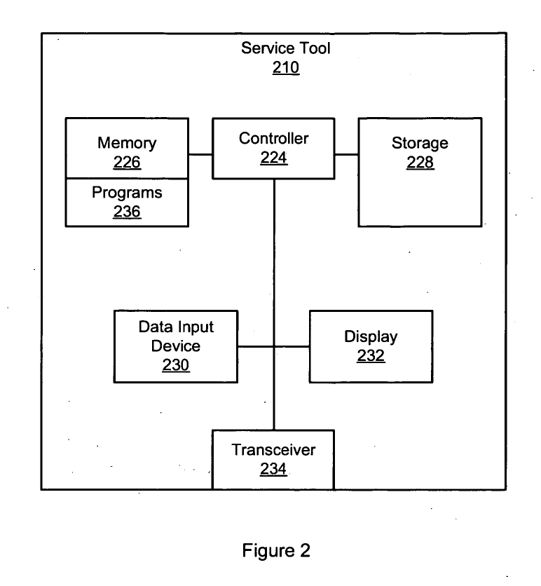

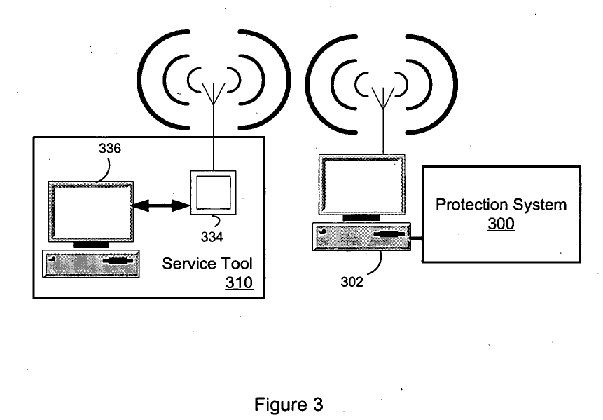

FIG. 2 illustrates a block diagram for an exemplary service tool 210 for a protection system. The service tool 210 may be any device or network of devices that may be configured or programmed to provide service functionality for a protection system. The service tool 210 may be a personal digital assistant (“PDA”), data processor, desktop computer, mobile computer, notebook computer, tablet computer, controller system, personal computer, workstation, mainframe computer, server, personal communications device such as a cellular telephone, network of computers such as a Local Area Network (“LAN”), a Wireless LAN (“WLAN”) a Personal Area Network (“PAN”), Wireless PAN (“WPAN”) and a Virtual Private Network (“VPN”), combinations thereof and the like. For example, the service tool 210 is a portable handheld device that communicates with a fire alarm control panel via a controller communicatively coupled with the fire alarm control panel.

The service tool 210 includes a controller 224, or central processing unit (CPU), memory 226, storage device 228, data input device 230, data output 232, and transceiver 234. The service tool also includes one or more mains and/or battery power connections (not shown), such as a 120 Vac, 24 Vac, 24 Vdc 12 Vdc, 9 Vdc and like power connections for supplying operating power for the service tool 210. The data output device 232 may be a display, monitor, a printer, a communications port, combinations thereof and the like.

A program 236 resides in the memory 226 and includes one or more sequences of executable code or coded instructions. The memory may be a random access memory (“RAM”), read-only memory (“ROM”), programmable read-only memory (“PROM”), erasable programmable read only memory (“EPROM”), electronically erasable programmable read only memory (“EEPROM”), Flash memory or any combination thereof or any memory type existing now or in the future. The program 236 may be implemented as computer software or firmware including object and/or source code, hardware, or a combination of software and hardware. The program 236 may be stored on a computer-readable medium, (e.g., storage device 228) installed on, deployed by, resident on, invoked by and/or used by one or more controllers 224, computers, clients, servers, gateways, or a network of computers, or any combination thereof. The program 236 is loaded into the memory 226 from storage device 228. Additionally or alternatively, the code may be executed by the controller 224 from the storage device 228. The program 236 may be implemented using any known or proprietary software platform or frameworks including basic, Visual Basic, C, C+, C++, J2EE™, Oracle 9i, XML, API based designs, and like software systems.

The controller 224 may be a general processor, central processing unit, digital signal processor, control processor, application specific integrated circuit, field programmable gate array, analog circuit, digital circuit, combinations thereof or other now known or later developed devices for implementing a control process. The controller 224 executes one or more sequences of instructions of the program 236 to process data. Data and/or instructions are input to the service tool 210 with data input device 230. Data and/or instructions are input to the service tool 210 via the transceiver 234. The controller 224 interfaces data input device 230 and/or the transceiver 234 for the input of data and instructions. Data processed by the controller 224 is provided as to output device 232. For example, data processed by the controller may be presented in a human readable format, such as in textual, graphical, and/or video format on a monitor. The data also or alternatively may be provided in an audible format or combination audible and visual format. The data processed by the controller may also be provided to an external output device and/or stored in the data storage device 228 for later access. The controller 224 through the programs 236 may be configured to provide the functionality of the service tool 210. The controller 224 performs the instructions of the program 236 in memory 226 to provide the features of the service tool 210. The controller 224 may also interface the storage device 228 for storage and retrieval of data.

The transceiver 234 may is a receiver, transmitter, a wireless communication port, a wireless communication device, a modem, a wireless modem and like device configured to wirelessly receive and/or transmit information. Alternatively or in addition, the transceiver may include one or more ports for a wired communication, such as RS-485, Ethernet or any other type of wire port. The transceiver 234 communicates information using one or a combination of one-way and/or two-way wireless communications, such as radio frequency (RF), infra-red (IR), ultra-sound communications, cellular radio-telephone communications, a wireless telephone, a Personal Communication Systems (PCS) and like wireless communication technologies. The transceiver 234 may communicate information or packets of information according to one or more communications protocols or standards, including IEEE 802.11(x), 802.14, 802.15, 802.16, Wi-Fi, Wi-Max, ZigBee, Bluetooth, Voice Over Internet Protocol (VoIP). The transceiver 234 also or alternatively may communicate information and/or packets of information in accordance with known and proprietary network protocols such as TCP/IP, Ethernet and like protocols over a Personal Area Network (PAN), Wireless PAN (WPAN), virtual private network (VPN), Wireless Local Area Network (WLAN) and other networks. The transceiver may also include an interrogator that wirelessly transmits signals to interrogate components of a protection system.

FIG. 5 illustrates an example of a wireless service tool 310 in communication with a protection system 300. The wireless service tool 310 includes a wireless transceiver 334 coupled to a processor 336. The protection system 300 may have a field panel coupled with a workstation 302 for communicating with the service tool. For example, the workstation 302 may be a laptop computer that is coupled via a RS-232 port or universal serial bus (“USB”) to the fire alarm control panel. The workstation 302 is configured to wirelessly communicate information. The workstation 302 may be programmed with software to collect or read information from one or fire field panels and wireless report the information to the service tool. Using software resident on the workstation, such as Pebbles PC or other application or program, the workstation 302 provides a user interface for displaying information associated with the protection system 300. The workstation 302 may transmit the information to the service tool and the service tool 310 may communicate with field panels via the workstation 302. Although shown as separate components, the workstation may be integral to the protection system 300 or component thereof.

Through the wireless transceiver 334, the service tool 310 may communicate with the workstation 302 protection system 300 over one or more RF communication channels. The communication of information between the service tool 310 and the protection system allows the service tool 310 to provide remote control and functionality of a device of the protection system 300. The service tool may allow remote operation of a field panel using commands entered at the service tool and transmitted to the field panel via the workstation 302. For example, a user may enter an acknowledge, silence, reset or other field panel control command with the wireless tool 310. The wireless transceiver communicates the command to the field panel, which executes the command. The wireless transceiver allows remote monitoring of communications of the protection system 300. The wireless transceiver 334 may include an indicator, such as one or more blinking lights, one or more LED's and LCD display and any other indicator, to indicate the wireless transceiver 334 is receiving, transmitting, and/or monitoring, communications. The wireless communication parameters of the protection system 300 may also be manually of automatically set.

The wireless transceiver 334 wirelessly receives or reads data. The data may be provided to the processor 336. Using software, such as Pebbles PC or other application or program, the processor 336 provides a user interface to displays information received by the wireless transceiver 334 from the protection system 500. The processor 336 may also include software to allow a user to wirelessly adjust, modify or test, the protection system and its components. The processor 536 may store data collected and/or processed. The user interface or man-machine interface allows the service tool 310 to receive input from a user and provide information to the user. The user interface may include one or more devices such as a keyboard, mouse, touch pad, touch screen, scanner, joystick, microphone, voice recognition software, combinations thereof and the like. The interface may include a menu of options for an operation, function and/or command. Based on a selection, the service tool may control additional features of the service tool and/or communicate information with the protection system 300.

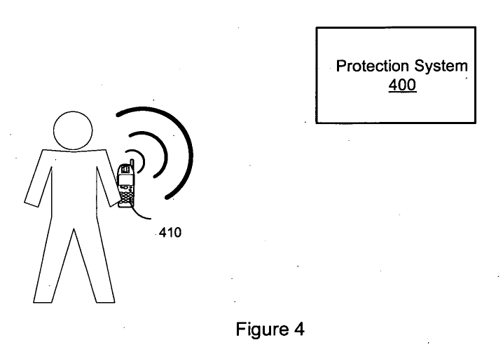

FIG. 4 illustrates an example of a service tool 410 configured as a handheld device, such as PDA device. The service tool 410 displays real-time graphical information related to a protection system. The information may be displayed on a screen. The user may move about a building or facility environment with the handheld service tool 410. As the user moves about the environment, the service tool may operate to collect data, diagnose problems, and/or configure the building system using one or different links. Using the interface, a user of the service tool 410 may perform operate or control the protection system in any of various modes. For example, the service tool 410 may be operated to allow National Fire Protection Association (NFPA) testing. The service tool 410 also may allow troubleshooting of components such as an alarm. For example, using the service tool, a technician may request an alarm to acknowledge or operate. Because the service tool 410 remotely operates the field panel, the technician may be proximate the alarm when a command from the service tool to sound the alarm is provided to the field panel. Similarly, the service tool may be used for supervisory control and testing of the protection system 400, may identify a malfunctioning device, a ground fault in a circuit and other troubleshooting areas.

While the invention has been described above by reference to various embodiments, it should be understood that many changes and modifications can be made without departing from the scope of the invention. For example, the service tool and its components may be adapted for servicing and troubleshooting industrial control equipment, environmental quality, security, lighting systems and integrated systems including combinations thereof. The service tool may also be configured with mapping software that allows a user to record and store service information with a corresponding position on a map of a building. The service tool may be used with integrated systems where, for example, an environmental control system may be integrated with a fire detection and prevention system.

The description and illustrations are by way of example only. Many more embodiments and implementations are possible within the scope of this invention and will be apparent to those of ordinary skill in the art. The various embodiments are not limited to the described environments, and have a wide variety of applications including integrated building control systems, environmental control, security detection, communications, industrial control, power distribution, lighting control, and hazard reporting.

It is intended that the appended claims cover such changes and modifications that fall within the spirit, scope and equivalents of the invention. The invention is not to be restricted except in light as necessitated by the accompanying claims and their equivalents. Therefore, the invention is not limited to the specific details, representative embodiments, and illustrated examples in this description.

We claim:

1. A service tool for a fire protection system having a plurality of distributed components, the service tool comprising:
a transceiver operable to wirelessly communicate information with at least one component of the fire protection system; and
a controller configured to process information received from the at least one component of the fire protection system, the information being received via the transceiver; and
a user interface operable to visually display the processed information in a user readable format.

2. The service tool of claim 1 where the information received from the fire protection system comprises a status of the fire protection system.

3. The service tool of claim 1 where the information received from the first protection system comprises diagnostic information of the at least one component.

4. The service tool of claim 1 where the at least one component comprises a fire alarm control panel.

5. The service tool of claim 4 comprising a user interface operable to receive a command for the fire alarm control panel, the command being communicated with fire protection control panel via the transceiver.

6. The service tool of claim 5 where the command is associated with a testing for the fire alarm control panel.

7. The service tool of claim 1 where the service tool wirelessly receives supervisory information from the fire alarm control panel.

8. The service tool of claim 1 where the service tool remotely controls the fire alarm control panel using wirelessly communicated commands received via the user interface.

9. The service tool of claim 1 where the controller and transceiver comprise a unitary part of the service tool.

10. A service tool for a distributed fire protection system having a plurality of remotely located devices, the service tool comprising:
means for wirelessly communicating with at least one device of the fire protection system;
means for wirelessly receiving information related to the fire protection system in response to the communication with the at least one device of the fire protection system; and
means for displaying the information related to the fire protection system received in response to the communication with the at least one device.

11. The service tool of claim 10, where the information related to the fire protection system comprises a status for the fire protection system.

12. The service tool of claim 11, further comprising means for displaying at least one control command for the fire protection system.

13. The service tool of claim 12, further comprising means for receiving a user command for the fire protection system.

14. The service tool of claim 13, further comprising means for wirelessly communicating the user command to the fire protection system in response to receiving the user command.

15. The service tool of claim 12, where the at least one control command corresponds to a control command displayed by a component of the fire protection system.

16. The service tool of claim 12 further comprising means for displaying a supervisory notification in response to wirelessly receiving information from the fire protection system.

17. A method for wirelessly servicing a building fire protection system, the method comprising:
receiving a user service command;
wirelessly communicating, in response to receiving the user service command, with at least one of a plurality of devices of the building fire protection system using a mobile transceiver;
in response to wirelessly communicating, receiving information associated with a status of at least one of a plurality of devices of the building fire protection system using the mobile transceiver; and
displaying the received information in a user readable format.

18. The method of claim 17 further comprising:
displaying real-time location specific information for the fire protection system using a mobile display, the information being updated as the transceiver changes locations within a building environment.

19. The method of claim 17 further comprising remotely controlling at least one component of the fire protection using a command wirelessly transmitted to the at least one component using a mobile transceiver.

20. The method of claim 17 further comprising wirelessly communicating with a control panel of the fire protection system using the mobile transceiver.
